(19) United States
(12) Patent Application Publication
(10) Pub. No.: US 2007/0203052 A1
(43) Pub. Date: Aug. 30, 2007

(54) Laundry Composition

(76) Inventors: Elizabeth Sylvia Cheater, Bebington (GB); Robert John Crawford, Bebington (GB); Ian Howell, Bebington (GB); Vincent Charles Mole, Bebington (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/583,232

(22) PCT Filed: Dec. 1, 2004
(86) PCT No.: PCT/EP04/13952

§ 371 Date: Mar. 27, 2007

(30) Foreign Application Priority Data
Dec. 16, 2003 (GB) 0329129.1

(51) Int. Cl. C11D 17/00

(52) U.S. Cl. 510/447

(57) ABSTRACT

The Laundry composition of the invention contains a particulate brightener comprising a fluorescent whitening agent and a carrier in combination with a deposition aid, in order to deposit particulate brightener on to consumer articles during the wash.

The present invention relates to laundry detergent compositions containing a particulate brightener comprising a fluorescent whitening agent and a carrier in combination with a deposition aid to improve the whitening of consumer articles during the laundry wash process.

Fluorescent whitening agents for use in laundry detergents to brighten cotton fabrics are known. The fluorescers are utilised on cotton and blends that have lost their fluorescence due to washing or breakdown in ultraviolet light. Typically the fluorescers are in the form of small molecules that penetrate the pores of cotton fibres or cellulosic fibres, diffusing into the fibre, causing them to fluoresce.

Fluorescent whitening agents are also known to whiten compositions into which they are incorporated to provide for the improved appearance of such compositions.

WO 00/58432 (Ciba) discloses the use of a brightener pigment comprising a water insoluble polymer compound and a water soluble fluorescent whitening agent for increasing the degree of whiteness of detergents or cleansers, of compounds thereof and of individual raw materials, also the method of preparing such.

WO 00/58431 (Ciba) discloses the use of a brightener pigment comprising a cellulose powder which is dispersible in water and a water soluble fluorescent whitening agent for increasing the whiteness of cleansers or detergents.

Additionally fluorescers are known to whiten goods during their manufacture. For example with respect to synthetic fibres which are smooth non-porous fibres, in order to achieve fibre penetration of the fluorescent whitening agent the fabric has to be raised above its glass transition temperature which is typically a high temperature, such as 100° C., as the fluorescent whitening agents can not penetrate these synthetic fibres at low temperatures.

WO 0198446 (Ciba) discloses a pigment comprising a derivative of formaldehyde and a fluorescent whitening agent. This is used as an optical whitener for paper, wood, foil, nonwovens and textiles during their manufacture, or alternatively for incorporation in detergent compositions as an agent to whiten said composition.

Despite the presence in the prior art of fluorescers which are added to synthetic fibres during the manufacture of such articles, the whitening of the compositions containing these fluorescent whitening agents, and the penetrative deposition of fluorescence in cotton fibres from the wash, there remains a need for the deposition of fluorescers on synthetic fibres during the wash process.

It has now surprisingly been discovered that consumer articles can be whitened during the wash process through the addition of a fluorescent whitening agent. This is achieved through the use of a particulate brightener comprising a fluorescent whitening agent and a carrier in combination with a deposition aid. This provides for the improved whitening of the fabric onto which it is deposited during the wash process, and especially synthetic fibre blends.

The invention lies in the fact that particulate brighteners that improve the whitening of synthetic fibre containing consumer articles in the wash process can be achieved through the addition of a deposition aid to a particulate brightener. This leads to the surface application of the particulate brightener to the consumer article during the wash process, even in the presence of a laundry detergent composition. This obviates the need to rely on the fibre penetration of the fluorescent whitening agent itself via a molecular adsorption process.

The use of these particulate brighteners with a deposition aid provides for the improved whitening and fluorescence of a wide range of different fabric types both cotton and synthetic and blends. The use of these particulate brighteners with a deposition aid also provides for increased stability of the whiteness as the whiteness is maintained over a period of time. The use of this combination provides also for antisoiling benefits.

### DEFINITION OF THE INVENTION

The present invention provides for a laundry composition comprising a particulate brightener, the particulate brightener comprising a fluorescent whitening agent and a carrier, characterised in that the particulate brightener has a deposition aid which deposits the particulate brightener on to consumer articles during the laundry wash process.

According to a second aspect of the invention there is provided the use of a particulate brightener to whiten consumer articles during the wash process.

According to a third aspect of the invention there is provided a process for the laundering of textile fabrics which comprises; a wash step in which the fabrics are immersed in an aqueous wash liquor comprising the particulate brightener as disclosed above, a detergent surfactant, optionally a detergency builder and optionally other detergent ingredients.

According to a fourth aspect of the invention there is provided a process for the laundering of textile fabrics which comprises;
(a) a wash step in which the fabrics are immersed in an aqueous wash liquor comprising a detergent surfactant, a detergency builder and optionally other detergent ingredients, and
(b) a rinse or pretreatment step in which the fabrics are immersed for at least 30 seconds in an aqueous rinse liquor comprising at least 1 wt % of a particulate brightener and a deposition aid, and optionally a non-surfactant water soluble salt.
   The Particulate Brightener

The particulate brightener is made up of the fluorescent whitening agent and the carrier as described below.

These are connected to one another to form a complex and this may be effected via a chemical bond.

The Fluorescent Whitening Agent

The laundry composition in accordance with the invention contains a fluorescent whitening agent which is an organic compound that absorbs ultraviolet light or radiation from an external source and remits some or all of the absorbed energy in a fluorescent light. Those materials usually preferred for textile whitening emit visible light in the blue region of the spectrum, namely between 380 and 500 nm.

According to a preferred embodiment of the invention the fluorescent whitening agent is present at levels of from 0.01 to 50 wt % based on the total weight percent of the particulate brightener. Preferably the fluorescent whitening agent is present at levels of from 0.1 to 15 wt % based on the total weight percent of the particulate brightener. More preferably the fluorescent whitening agent is present at levels of from 0.5 to 10 wt % based on the total weight percent of the particulate brightener. Most preferably the fluorescent whitening agent is present at levels of from 1 to 8 wt % based on the total weight percent of the particulate brightener.

According to a preferred embodiment of the invention the fluorescent whitening agent is present at levels of from 0.0005 to 10 wt % of the composition based on the total weight percent of the composition. Preferably the fluorescent whitening agent is present at levels of from 0.001 to 5 wt % of the composition based on the total weight percent of the composition. More preferably the fluorescent whitening agent is present at levels of from 0.002 to 4 wt % of the composition based on the total weight percent of the composition.

In a preferred embodiment the composition may contain traditional fluorescent whitening agents such as Tinopal CBS-X ex CIBA.

The fluorescent whitening agent may include various structures such as those outlined in the review article, ‘Optical Brighteners’, J. Kaschig, Industrial Dyes, K. Hunger (ed.), Wiley V C H, Weinheim, 2002. For example it may include hydrophobic fluorescent whitening agents.

In a further preferred embodiment the fluorescent whitening agent correspond to the following formula: 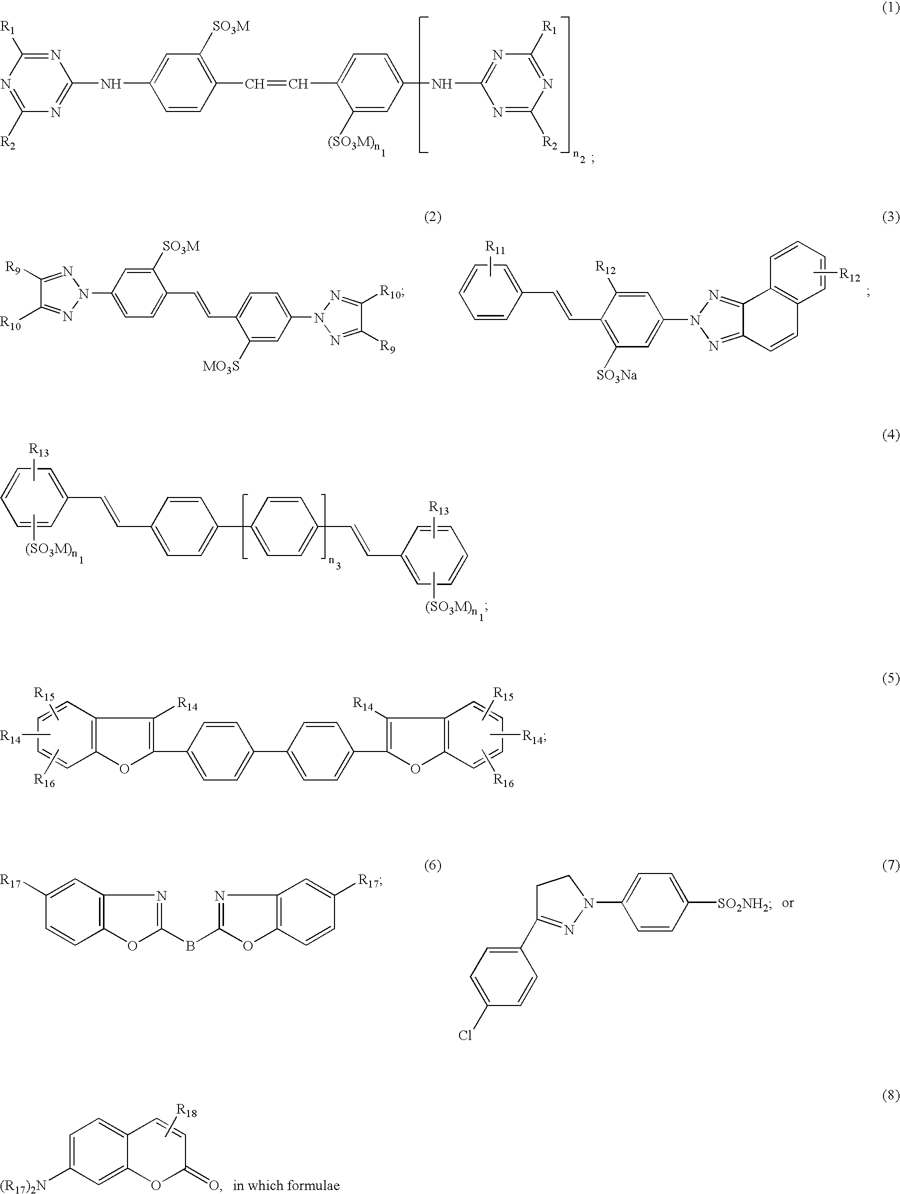
each R₁ is independently from each other a radical of 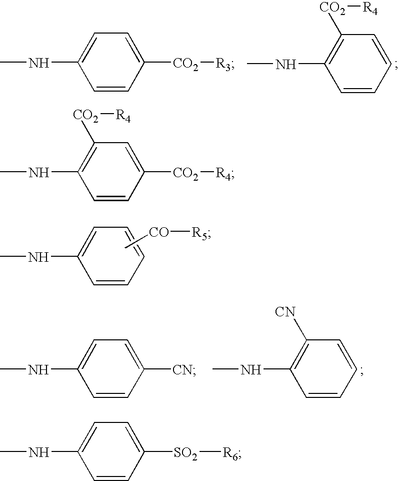
   —OH, —Cl; —NH₂; —O—C₁-C₄alkyl; —O-aryl; —NH—C₁-C₄alkyl; —N(C₁-C₄alkyl)₂; —N(C₁-C₄alkyl) (C₁-C₄hydroxyalkyl); —N(C₁-C₄hydroxyalkyl)₂; —NH-aryl; morpholino; —S—C₁-C₄alkyl or —S-aryl;
each R₂ is independently from each other hydrogen; a radical of formula 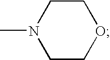
   —OH; —NH₂; —N(CH₂CH₂OH)₂; —N[CH₂CH(OH)CH₃]₂; —NH—R₄; —N(R₄)₂; —OR₄; —Cl; —N(C₁-C₄alkyl) (C₁-C₄hydroxyalkyl); —N(C₁-C₄hydroxyalkyl)₂; —S—C₁-C₄alkyl or —S-aryl;
R₃ is an unsubstituted or substituted alkyl or aryl group;
each R₄ is independently from each other M, or an unsubstituted or substituted alkyl or aryl group;
R₅ is hydrogen; an unsubstituted or substituted alkyl or aryl group; or —NR₇R₈,
   wherein R₇ and R₈ are each independently of the other hydrogen or an unsubstituted or substituted alkyl or aryl group, or R₇ and R₈ together with the nitrogen atom linking them form a heterocyclic radical, especially a morpholino or piperidino radical;
R₆ is hydrogen, or an unsubstituted or substituted alkyl or aryl group;
R₉ and R₁₀ are each independently of the other hydrogen, C₁-C₄alkyl, phenyl or a radical of formula 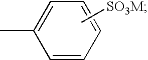
R₁₁ is hydrogen, —Cl or SO₃M;
each R₁₂ is independently from each other —CN; —SO₃M; —S(C₁-C₄alkyl)₂ or —S(aryl)₂;
each R₁₃ is independently from each other is hydrogen; —SO₃M; —O—C₁-C₄alkyl; —CN; —Cl; —COO—C₁-C₄alkyl or —CON(C₁-C₄alkyl)₂;
each R₁₄ is independently from each other hydrogen; —C₁-C₄alkyl; —Cl or —SO₃M;
R₁₅ and R₁₆ are each independently of the other hydrogen, C₁-C₄alkyl; —SO₃M; —Cl or —O—C₁-C₄alkyl;
each R₁₇ is independently of the other hydrogen or C₁-C₄alkyl;
R₁₈ is hydrogen, C₁-C₄alkyl; —CN; —Cl; —COO-C₁-C₄alkyl; —CON(C₁-C₄alkyl)₂; aryl or —O-aryl;
B is; 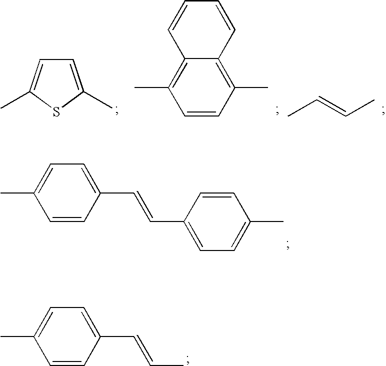
M is hydrogen; sodium; potassium; calcium; magnesium; ammonium; mono- di- tri- or tetra-C₁-C₄alkylammonium; mono-, di- or tri-C₁-C₄hydroxyalkylammonium; or ammonium di- or tri-substituted by a mixture of C₁-C₄alkyl and C₁-C₄hydroxyalkyl groups; and
n₁, n₂ and n₃ are each independently of the others 0 or 1.

R₃, R₄, R₅, R₆, R₇ and R₈ representing (unsubstituted or) substituted alkyl are each C₁-C₁₂alkyl, preferably C₁-C₄alkyl. The alkyl groups may be branched or unbranched and may be unsubstituted or substituted by halogen, e.g. fluorine, chlorine or bromine, by C₁-C₄alkoxy, e.g. methoxy or ethoxy, by phenyl or carboxyl, by C₁-C₄alkoxycarbonyl, e.g. acetyl, by mono- or di-C₁-C₄alkylamino or by —SO₃M.

R₃, R₄, R₅, R₆, R₇, R₈, R₁₂, and R₁₈ representing (unsubstituted or) substituted aryl are each preferably a phenyl or naphthyl group that may be unsubstituted or substituted by C₁-C₄alkyl, e.g. methyl, ethyl, propyl, isopropyl, butyl, isobutyl, sec-butyl or tert-butyl, by C₁-C₄alkoxy, e.g. methoxy, ethoxy, propoxy, isopropoxy, butoxy, isobutoxy, sec-butoxy or tert-butoxy, by halogen, e.g. fluorine, chlorine or bromine, by C₂-C₅alkanoylamino, e.g. acetylamino, propionylamino or butyrylamino, by nitro, by sulfo or by di-C₁-C₄alkylated amino.

The compounds of formula (1) are used preferably in neutral form, that is to say:

M is preferably a cation of an alkali metal, especially sodium, or is an amine.

The fluorescent whitening agents that can be used advantageously in the present invention are listed by way of example in the following Table 1:

TABLE 1

| Compound | |
|---|---|
| of | |
| formula | |
| (9) | 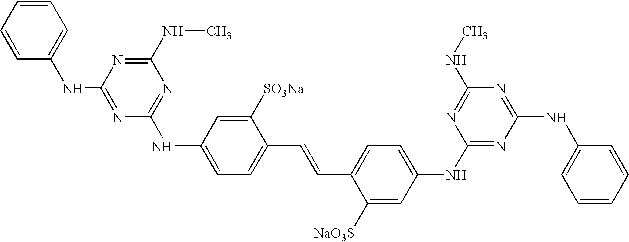 |
| (10) | 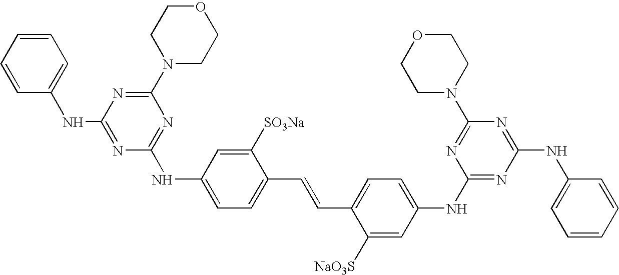 |
| (11) | 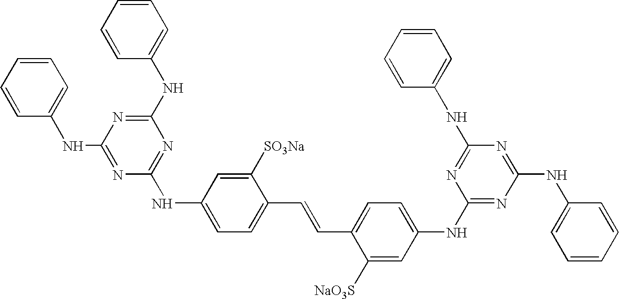 |
| (12) | 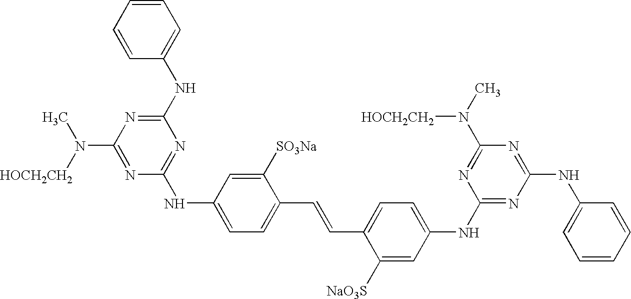 |
| (13) | 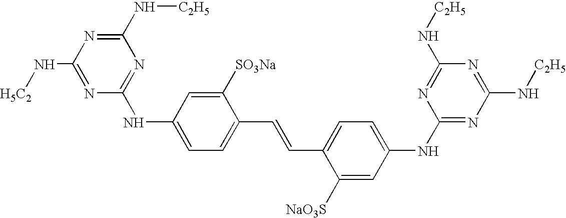 |
| (14) | 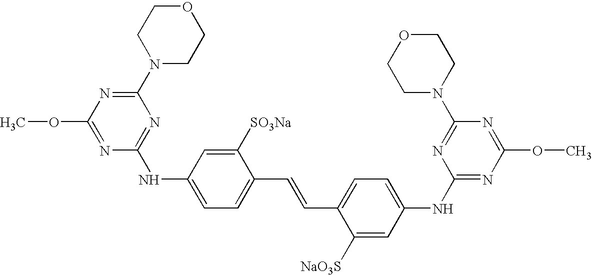 |
| (15) | 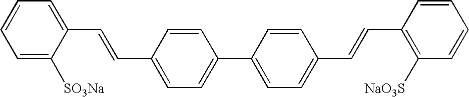 |
| (16) | 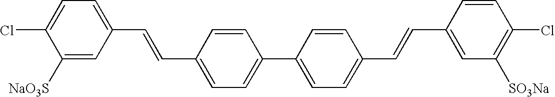 |
| (17) | 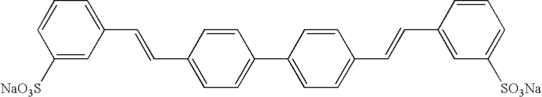 |
| (18) | 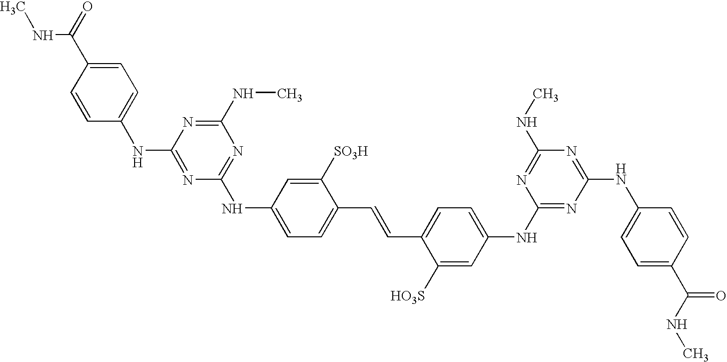 |
| (19) | 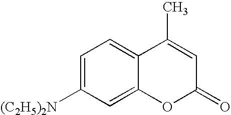 |
| (20) | 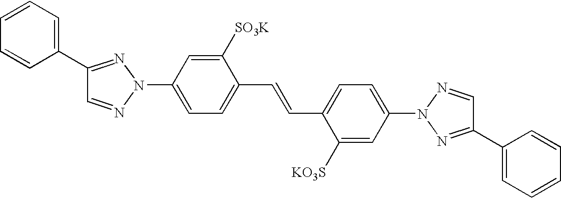 |
| (21) | 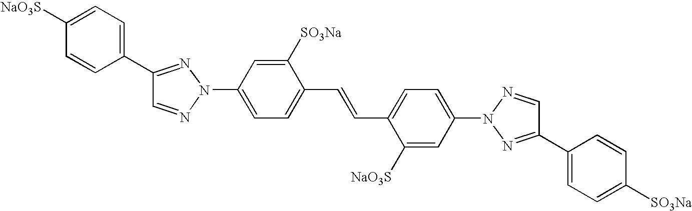 |
| (22) | 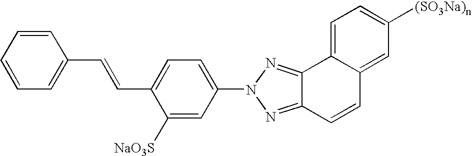 |
| (23) | 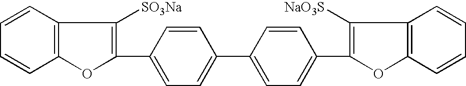 |
| (24) | 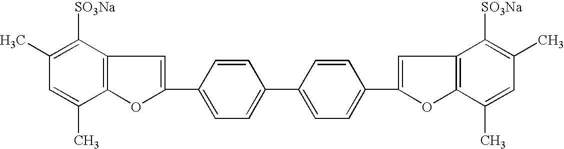 |
| (25) | 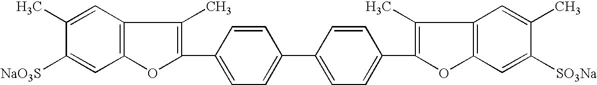 |
| (26) | 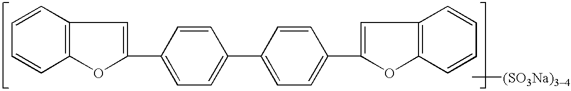 |

The Carrier

The laundry composition in accordance with the invention contains a carrier. The carrier may be material which is capable of interacting with the fluorescent whitening agent in a stable manner, that is it binds to the fluorescent whitening agent in the presence of laundry composition components, and the carrier does not prevent the activity of the fluorescent whitening agent on consumer articles during the wash when delivered by the deposition aid.

In a preferred embodiment according to the invention the laundry detergent composition comprises a particulate brightener wherein the carrier is urea formaldehyde.

It may be a highly disperse solid polymer compound formed by polymerisation, polycondensation or by polyaddition reactions, or even through a combination of such reactions.

Such polymer compounds are described in GB1323890 (Ciba-Geigy) and include condensation polymers, especially aminoplastic condensation polymers such as for example urea formaldehyde and melamine formaldehyde polymer compounds, and also vinyl polymers such as polyacrylonitrile.

Preferably there is used in accordance with the invention a urea formaldehyde resin of which the molar ratio of urea to formaldehyde is preferably from 1:1.3 to 1:2 moles. The urea formaldehyde is also distinguished by a small particle diameter of from 2 to 10 μm and a low BET specific surface area of from 15 to 120 m²/g. The BET specific surface area of the preferred urea formaldehyde resins is ascertained according to Brunauer, Emmett and Teller method in J. Am. Chem. Soc. 60, 309-319, (1938). The preferred urea formaldehyde resins and their preparation is known from A. Renner, Makromolekular Chemie 149, 1-27 (1971).

The carrier may be a polymer, clay, latex or coacervate, encapsulate, aluminosilicate, or a silicate.

The polymers may be solid, porous, or film forming and the polymers are capable of adsorbing and maintaining molecular fluorescer. The polymer carrier may also be grafted with the fluorescent whitening agent. The carrier may be a poly high internal phase emulsion polymer (polyHIPE) which is porous. The clays may include hydrotalcites. The aluminosilicates may be amorphous or crystalline.

The carrier may exist as a separate entity or alternatively the carrier may be an aggregate of smaller particles. The carrier may be soluble or insoluble, preferably it is insoluble.

A suitable carrier may be a liquid matrix binding of subparticles which results in a deformable carrier. These may include any material capable of binding subparticles together, for example silicone oils.

Similarly the carrier may be particles of the appropriate size or those that can be milled to the appropriate size. According to a preferred embodiment of the invention the particle size of the carrier in the wash solution is of from 0.01 μm to 50 μm. Preferably the particle size of the carrier is from 0.05 μm to 20 μm, more preferably the particle size of the carrier is from 0.1 μm to 10 μm.

The size of the carrier depends on the deposition mechanism and in particular for filtration the balance to be achieved is that large particles are easily deposited but also easily rinsed off. Smaller particles are hard to deposit but once deposited are difficult to remove. Thus there is an optimum particle size range where the deposition efficiency and retention are balanced, this depends on the substrate in question and the wash process employed. The upper particle size limit is defined by seeing dusting effects on dark fabrics and the lower limit is defined by ease of handling of the carrier material.

The Deposition Aid

The deposition aid may be any material that enhances the deposition of the carrier and the fluorescent whitening agent to the consumer article during the wash process, namely that it is fabric substantive. It must therefore be capable of binding the particulate brightener and the consumer articles.

This deposition aid may be complexed or chemically bound to the particulate brightener.

The consumer articles may include fabric which is nylon, polyester, acrylic, cotton or polycotton, linen, or wool or other such blends. The articles may include clothing items or other household items.

According to a preferred embodiment of the invention the deposition aid is a cationic polymer. The cationic nature of these polymers means that they are attracted to negatively charged particles in the wash.

In a preferred embodiment of the invention the cationic deposition aid is a cationic derivative of hydroxylethyl cellulose(HEC). In a further preferred embodiment of the invention the cationic deposition aid is UCARE JR30M. This has a good environmental profile.

Typical examples of other suitable HEC's include the Ucare series of polymers (ex. Amerchol), for example UCARE JR125, JR 400, LR30M, LR400.

Other examples of suitable cationic polymers include cationic polysaccharide derivatives, for example:

Other cationically modified cellulosic derivatives include copolymers of hydroxy ethyl cellulose and diallyldimethylammonium chloride, for example Celquat L200 (ex. National Starch).

Polymeric ammonium salt of HEC reacted with a lauryl dimethyl ammonium substituted epoxide (Quatrisoft LM-200 ex. Amerchol).

Other cationic polymers include cationically modified Guars. Typical examples include the Jaguar series of polymers (ex. Rhodia), for example Jaguar C13S, C14S, C162, C17, C1000.

Other suitable cationic polymers include cationic polymers prepared by the free radical (co)polymerisation of suitable monomers typical examples of these include:

Cationically modified polyacrylamide such as copolymers of acrylamide and beta-methylacryloxyethyltrimethyl ammonium methosulphate, for example Merquat 5 (ex. ONEDO NALCO).

Copolymers of acrylamide and dimethyldiallylammonium chloride (for example Salcare 7 ex. Ciba).

Quaternary ammonium polymer formed by the reaction of diethyl sulphate and a copolymer of vinyl pyrrolidone and dimethyl aminomethacrylate (for example Luviquat PQ11 ex. BASF).

Polymeric quaternary ammonium salt formed from methyl-vinylimidazolium chloride and vinyl pyrrolidone (for example Luviquat FC370 ex. BASF).

Polymeric quaternary ammonium salt consisting of vinylpyrrolidone and dimethylaminopropyl methacrylamide monomers (for example Gafquat HS-100 ex. ISP).

Acrylamide-dimethylaminoethyl methacrylate methyl chloride polymer (for example Salcare SC92 ex. CIBA).

N,N,N-trimethyl-2-[(methyl-1-oxo-2-propenyl)oxy]ethanaminium chloride homopolymer (for example Salcare SC95/96 ex. CIBA).

Polymeric quaternary ammonium salt consisting of vinylpyrrolidone and quaternerised imidazoline monomers (for example Luviquat Care ex. BASF).

Polymeric quaternary ammonium salt prepared by the reaction of vinylcaprolactam and vinylpyrrolidone with methylvinylimidazolium methosulphate (for example Luviquat ex. BASF).

Copolymer of dimethyldiallyl ammonium chloride (for example Merquat 280/295 ex. ONDEO NALCO).

Acrylamidopropyltrimonium chloride (for example Salcare SC60 ex. CIBA).

Cationic polyacrylamides (for example Zetag 7108, Zetag 7645 ex. CIBA).

Polyethylene imine (for example Lupasol P, Lupasol SK ex. BASF).

These polymers may be used as deposition aids via a precipitation mechanism, i.e. the cationic polymer is adsorbed onto the surface of the carrier and fluorescent whitening agent complex, forming a further complex which precipitates out with the anionic surfactant in solution. This cationic precipitate is then attracted to fabric surfaces. Alternatively, the polymer may act via a bridging mechanism, i.e. the cationic polymer forms a bridge between the particles it is absorbed on to, and the fabric surface.

The deposition aid could also be fabric substantive soil release polymers such as Gerol ex Rhodia, which is substantive to polyester consumer articles. Another soil release polymer is locust bean gum and sodium carboxymethyl cellulose which bind cotton.

The deposition aid may also be a cationic surfactant to make the particulate brightener fabric substantive.

The deposition aid may encompass a hydrophobic coating such as silicone, or hydrocarbon oils which makes the particulate brightener fabric substantive.

Alternatively the deposition aid may incorporate altering the electrostatic charge of the particulate brightener by for example quaternising or adding ammonium groups to the surface of the particulate brightener. This alters the zeta potential of the particulate brightener to enhance the deposition of the particulate brightener on to the consumer articles.

The deposition aid may also be a protein which is used to target the particulate brightener to the consumer article during the wash.

According to a second aspect of the invention there is provided the use of a particulate to whiten consumer articles during the wash process. The wash process may include the main wash cycle or pre-treatment or post-treatment of the consumer articles.

According to a third aspect of the invention there is provided a process for the laundering of textile fabrics which comprises;
(a) a wash step in which the fabrics are immersed in an aqueous wash liquor comprising a detergent surfactant, a detergency builder and optionally other detergent ingredients, and
(b) a rinse step in which the fabrics are immersed for at least 30 seconds in an aqueous rinse liquor comprising at least how much of a particulate brightener and a deposition aid, and optionally a non-surfactant water soluble salt.

The optional water-soluble salt is believed to be beneficial because it promotes dispersion. Any non-surfactant water-soluble salt may be used. The term “non-surfactant” salt is used because many surfactants, e.g. anionic surfactants are in the form of water soluble alkali metal salts and cationic surfactants are usually in water-soluble salt form with a counter-anion. For the non-surfactant water-soluble salts, salts of the metal cations with inorganic or organic anions are appropriate. A mixture of salts may also be used, but it is preferable to use a material which is widely available at low cost. Thus, one may use a soluble salt of a monovalent metal such as an alkali metal, for example sodium or potassium, e.g. as the chloride or sulphate. However, weight for weight, it is more effective to use a salt of a divalent metal, or a water-soluble salt of a metal having a valency of three or more. It could also be a water-soluble detergency builder such as an alkali metal citrate or tripolyphosphate. However, the best balance of economy of cost and effectiveness has been found to be obtained if the salt comprises magnesium ions. Magnesium chloride and/or sulphate are typical. The amount of salt used will depend on the valency of the metal but in the broadest concept, it will be used at a molar concentration of from 0.00M to 1M.

In the case of the magnesium salt, the molar concentration will usually be from 0.00M to 0.1M in the rinse liquor.

Surfactant

There are a number of surfactants which are suitable pursuant to the present invention.

Anionic surfactants are well-known to those skilled in the art. Many suitable detergent-active compounds are available and are fully described in the literature, for example, in “Surface-Active Agents and Detergents”, Volumes I and II, by Schwartz, Perry and Berch.

Examples include alkylbenzene sulphonates, branched or linear alkyl benzene sulphonates, primary and secondary alkylsulphates, particularly C₈-C₁₆ primary alkyl sulphates; alkyl ether sulphates, olefin sulphonates, including alpha olefin sulphonates, fatty alcohol sulphates such as primary alcohol sulphates, alkane sulphonates, alkyl xylene sulphonates, dialkyl sulphosuccinates, and fatty acid ester sulphonates, and alkyl carboxylates. Also suitable are ether sulphates such as sodium lauryl ether sulphate (SLES). These may be present as sodium, potassium, calcium or magnesium salts or mixtures of these. Sodium salts are generally preferred.

The anionic surfactant is preferably a sulphonate or sulphate anionic surfactant. More preferably the anionic surfactant is linear alkylbenzene sulphonate or primary alcohol sulphate. Most preferably the anionic surfactant is linear alkylbenzene sulphonate. The linear alkyl benzene sulphonate may be present as sodium, potassium, or alkaline earth metal salts, or mixtures of these salts. Sodium salts are generally preferred.

Nonionic surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpolyglycosides, glycerol monoethers, and polyhydroxyamides (glucamide).

Preferred water-soluble cationic surfactants are quaternary ammonium salts of the general formula III
R₁R₂R₃R₄N⁺X⁻ (III)
wherein R₁ is a relatively long (C₈-C₁₈) hydrocarbyl chain, typically an alkyl, hydroxyalkyl or ethoxylated alkyl group, optionally interrupted with a heteroatom or an ester or amide group; each of R₂, R₃ and R₄ (which may be the same or different) is a short-chain (C₁-C₃) alkyl or substituted alkyl group; and X is a solubilising anion, for example a chloride, bromide or methosulphate ion.

A preferred cationic surfactant is a quaternary ammonium compound of the formula II in which R₁ is a C₈-C₁₈ alkyl group, more preferably a C₈-C₁₀ or C₁₂-C₁₄ alkyl group, R₂ is a methyl group, and R₃ and R₄, which may be the same or different, are methyl or hydroxyethyl groups. Such compounds have the formula IV:

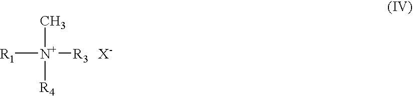

In an especially preferred compound, R₁ is a C₁₂-C₁₄ alkyl group, R₂ and R₃ are methyl groups, R₄ is a 2-hydroxyethyl group, and X⁻ is a chloride ion. This material is available commercially as Praepagen (Trade Mark) HY from Clariant GmbH, in the form of a 40 wt % aqueous solution.

Other classes of cationic surfactant include cationic esters (for example, choline esters).

Builder

The builder may be selected from strong builders such as phosphate builders, aluminosilicate builders and mixtures thereof. One or more weak builders such as calcite/carbonate, citrate or polymer builders may be additionally or alternatively present.

The phosphate builder (if present) may for example be selected from alkali metal, preferably sodium, pyrophosphate, orthophosphate and tripolyphosphate, and mixtures thereof.

The aluminosilicate (if present) may be, for example, selected from one or more crystalline and amorphous aluminosilicates, for example, zeolites as disclosed in GB 1 473 201 (Henkel), amorphous aluminosilicates as disclosed in GB 1 473 202 (Henkel) and mixed crystalline/amorphous aluminosilicates as disclosed in GB 1 470 250 (Procter & Gamble); and layered silicates as disclosed in EP 164 514B (Hoechst).

The alkali metal aluminosilicate may be either crystalline or amorphous or mixtures thereof, having the general formula: 0.8-1.5 Na₂O. Al₂O₃. 0.8-6 SiO₂.

These materials contain some bound water and are required to have a calcium ion exchange capacity of at least 50 mg CaO/g.

The preferred sodium aluminosilicates contain 1.5-3.5 SiO₂ units (in the formula above). Both the amorphous and the crystalline materials can be prepared readily by reaction between sodium silicate and sodium aluminate, as amply described in the literature. Suitable crystalline sodium aluminosilicate ion-exchange detergency builders are described, for example, in GB 1 429 143 (Procter & Gamble). The preferred sodium aluminosilicates of this type are the well-known commercially available zeolites A and X, and mixtures thereof.

The zeolite may be the commercially available zeolite 4A now widely used in laundry detergent powders. However, according to a preferred embodiment of the invention, the zeolite builder incorporated in the compositions of the invention is maximum aluminium zeolite P (zeolite MAP) as described and claimed in EP 384 070A (Unilever). Zeolite MAP is defined as an alkali metal aluminosilicate of the zeolite P type having a silicon to aluminium ratio not exceeding 1.33, preferably within the range of from 0.90 to 1.33, and more preferably within the range of from 0.90 to 1.20.

Especially preferred is zeolite MAP having a silicon to aluminium ratio not exceeding 1.07, more preferably about 1.00. The calcium binding capacity of zeolite MAP is generally at least 150 mg CaO per g of anhydrous material. Suitable inorganic salts include alkaline agents such as alkali metal, preferably sodium, carbonates, sulphates, silicates, metasilicates as independent salts or as double salts. The inorganic salt may be selected from the group consisting of sodium carbonate, sodium sulphate, burkeite and mixtures thereof.

As well as the surfactants and builders discussed above, the compositions may optionally contain other active ingredients to enhance performance and properties.

The detergent composition may further comprise one or more additional surfactants. Additional surfactants or detergent active compounds may comprise other nonionics such as alkylpolyglucosides, polyhydroxyamides (glucamide), and glycerol monoethers. Also amphoteric surfactants and/or zwitterionic surfactants may be present. Preferred amphoteric surfactants are amine oxides, for example coco dimethyl amine oxide. Preferred zwitterionic surfactants are betaines, and especially amidobetaines. Preferred betaines are C8 to C18 alkyl amidoalkyl betaines, for example coco amido betaine. These may be included as co-surfactants. Many suitable detergent active compounds are available and are fully described in the literature, for example in “Surface-Active Agents and Detergents”, volumes I and II by Schwartz, Perry, and Berch.

The detergent compositions of the invention may comprise one or more optional ingredients selected from soap, peroxyacid and persalt bleaches, bleach activators, air bleach catalysts, sequestrants, cellulose ethers and esters, cellulosic polymers, other antiredeposition agents, sodium chloride, calcium chloride, sodium bicarbonate, other inorganic salts, fluorescers, photobleaches, polyvinyl pyrrolidone, other dye transfer inhibiting polymers, foam controllers, foam boosters, acrylic and acrylic/maleic polymers, proteases, lipases, cellulases, amylases, other detergent enzymes, citric acid, soil release polymers, silicone, fabric conditioning compounds, coloured speckles such as blue speckles, and perfume. This list is not intended to be exhaustive.

Yet other materials that may be present in detergent compositions of the invention lather control agents or lather boosters as appropriate; dyes and decoupling polymers.

Suitable lather boosters for use in the present invention include cocamidopropyl betaine (CAPB), cocomonoethanolamide (CMEA) and amine oxides.

Preferred amine oxides are of the general form: 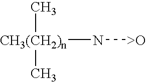
where, n is from 7 to 17.

A suitable amine oxide is Admox (Trademark) 12, supplied by Albemarle.

Bleaches

Detergent compositions according to the invention may suitably contain a bleach system. The bleach system is preferably based on peroxy bleach compounds, for example, inorganic persalts or organic peroxyacids, capable of yielding hydrogen peroxide in aqueous solution. Suitable peroxy bleach compounds include organic peroxides such as urea peroxide, and inorganic persalts such as the alkali metal perborates, percarbonates, perphosphates, persilicates and persulphates. Preferred inorganic persalts are sodium perborate monohydrate and tetrahydrate, and sodium percarbonate. Especially preferred is sodium percarbonate having a protective coating against destabilisation by moisture. Sodium percarbonate having a protective coating comprising sodium metaborate and sodium silicate is disclosed in GB 2 123 044B (Kao).

The peroxy bleach compound is suitably present in an amount of from 5 to 35 wt %, preferably from 10 to 25 wt %.

The peroxy bleach compound may be used in conjunction with a bleach activator (bleach precursor) to improve bleaching action at low wash temperatures. The bleach precursor is suitably present in an amount of from 1 to 8 wt %, preferably from 2 to 5 wt %.

Preferred bleach precursors are peroxycarboxylic acid precursors, more especially peracetic acid precursors and peroxybenzoic acid precursors; and peroxycarbonic acid precursors. An especially preferred bleach precursor suitable for use in the present invention is N,N,N′,N′-tetracetyl ethylenediamine (TAED). Also of interest are peroxybenzoic acid precursors, in particular, N,N,N-trimethylammonium toluoyloxy benzene sulphonate.

A bleach stabiliser (heavy metal sequestrant) may also be present. Suitable bleach stabilisers include ethylenediamine tetraacetate (EDTA) and the polyphosphonates such as Dequest (Trade Mark), EDTMP.

Alternatively the present invention may be used in a formulation that is used to bleach via air, or an air bleach catalyst system. In this regard the bleaching composition substantially devoid of a peroxygen bleach or a peroxy-based or peroxyl-generating bleach system.

The term “substantially devoid of a peroxygen bleach or a peroxy-based or peroxyl-generating bleach system” should be construed within spirit of the invention. It is preferred that the composition has as low a content of peroxyl species present as possible. It is preferred that the bleaching formulation contains less that 1% wt/wt total concentration of peracid or hydrogen peroxide or source thereof, preferably the bleaching formulation contains less that 0.3% wt/wt total concentration of peracid or hydrogen peroxide or source thereof, most preferably the bleaching composition is devoid of peracid or hydrogen peroxide or source thereof. In addition, it is preferred that the presence of alkyl hydroperoxides is kept to a minimum in a bleaching composition comprising the ligand or complex of the present invention.

In order to function as an air bleaching composition the bleaching composition comprises an organic substance which forms a complex with a transition metal for bleaching a substrate with atmospheric oxygen.

The bleach catalyst per se may be selected from a wide range of transition metal complexes of organic molecules (ligands). In typical washing compositions the level of the organic substance is such that the in-use level is from 0.05 μM to 50 mM, with preferred in-use levels for domestic laundry operations falling in the range 1 to 100 μM. Higher levels may be desired and applied in industrial textile bleaching processes.

Suitable organic molecules (ligands) for forming complexes and complexes thereof are found, for example in: WO-A-98/39098; WO-A-98/39406, WO 9748787, WO 0029537; WO 0052124, and WO0060045 the complexes and organic molecule (ligand) precursors of which are herein incorporated by reference. An example of a preferred catalyst is a transition metal complex of MeN4Py ligand (N,N-bis(pyridin-2-yl-methyl)-1,1-bis(pyridin-2-yl)-1-aminoethane).

Enzymes

The detergent compositions may also contain one or more enzymes. Suitable enzymes include the proteases, amylases, cellulases, oxidases, peroxidases, savinases and lipases usable for incorporation in detergent compositions.

In particulate detergent compositions, detergency enzymes are commonly employed in granular form in amounts of from about 0.1 to about 3.0 wt %. However, any suitable physical form of enzyme may be used in any effective amount.

Other

The composition may contain traditional fluorescent whitening agents such as Tinopal CBS-X ex CIBA.

Antiredeposition agents, for example cellulose esters and ethers, for example sodium carboxymethyl cellulose, may also be present. An example of a commercially available sodium carboxymethyl cellulose is Finnfix BDA (trademark), ex Noviant.

The compositions may also contain soil release polymers, for example sulphonated and unsulphonated PET/POET polymers, both end-capped and non-end-capped, and polyethylene glycol/polyvinyl alcohol graft copolymers such as Sokalan (Trade Mark) HP22. Especially preferred soil release polymers are the sulphonated non-end-capped polyesters described and claimed in WO 95 32997A (Rhodia Chimie).

Powder flow may be improved by the incorporation of a small amount of a powder structurant, for example, a fatty acid (or fatty acid soap), a sugar, an acrylate or acrylate/maleate copolymer, or sodium silicate. One preferred powder structurant is fatty acid soap, suitably present in an amount of from 1 to 5 wt %, based on the weight of the total composition.

Form of the Composition

The compositions of the invention may be of any suitable physical form, for example, particulates (powders, granules, tablets), liquids, pastes, gels or bars.

According to one especially preferred embodiment of the invention, the detergent composition is in particulate form, preferably powder form.

The composition can be formulated for use as hand wash or machine wash detergents. It may also include a pre-wash, post-wash namely a rinse product, an adjunct to the mainwash or a specific brightening product such as a spray, or a soak product or a boost product.

Preparation of the Compositions

The compositions of the invention may be prepared by any suitable process.

Powders of low to moderate bulk density may be prepared by spray-drying a slurry, and optionally postdosing (dry-mixing) further ingredients. “Concentrated” or “compact” powders may be prepared by mixing and granulating processes, for example, using a high-speed mixer/granulator, or other non-tower processes.

Tablets may be prepared by compacting powders, especially “concentrated” powders.

Liquid detergent compositions may be prepared by admixing the essential and optional ingredients in any desired order to provide compositions containing the ingredients in the requisite concentrations.

The choice of processing route may be in part dictated by the stability or heat-sensitivity of the surfactants involved, and the form in which they are available.

In all cases, ingredients such as enzymes, bleach ingredients, sequestrants, polymers and perfumes may be added separately.

### EXAMPLES

The invention will now be further illustrated by the following non-limiting examples, in which parts and percentages are by weight.

### Example 1

The following example shows particulate brightener delivery onto consumer articles from the wash.

The particulate brightener contains urea formaldehyde as the carrier. It also contains CBS-X the fluorescent whitening agent at 4 wt %, based on the weight of the particulate brightener.

The deposition aid used was polymer JR30M a cationic hydroxyethyl cellulose ex Dow, with a mean molecular weight of approximately 1,000,000 and a mean charge density of approximately 0.8 meq/g.

The wash conditions employed for this experiment are as follows. First of all there is pre-treatment of particulate brightener (0.5 g/l) with the polymer. This involved adding the pigment and polymer solution, (at various levels) to a tergopot.

This particulate brightener and deposition aid complex (polymer complex) was then either not added, (i.e. for the 0 ppm control), or added at various different levels, from 1 to 15 ppm (parts per million), to a detergent product as detailed in Table 1 below.

TABLE 1

| Ingredient | Weight % |
|---|---|
| Linear alkyl benzene | 27.75 |
| sulphonate | |
| Alkaline silicate | 8.90 |
| Neutral silicate | 2.66 |
| Sodium tripolyphosphate | 18.50 |
| Sodium carboxymethyl | 0.77 |
| cellulose | |
| Sodium sulphate | 30.84 |
| Moisture | 9.00 |
| CBS-X | 0.08 |
| Minor Ingredients | 1.50 |

A 30 minute wash using a tergotometer was carried out using this detergent product at an ambient wash temperature of 25° C. with a 6° FH water (3:1 Ca:Mg). Then two rinses were carried out.

The Ganz Whiteness Index is a colour measurement index widely used in the textile and paper industries. The target substrate is measured with a reflectometer equipped with a calibrated light source and integrating sphere, and the resultant spectrum used to derive a whiteness value and a tint value according to the formulae:

$$\begin{matrix}Whiteness ( W ) & = Y - 1869.3 x - 3695.2 y + 1809.3 \\ Tint & = - 1001.223 x + 748.366 y + 68.261\end{matrix}$$

Where Y is the Y-tristimulus value of the substrate, and x and y are the CIE (or the International Commission on Illumination publication) chromatography co-ordinates derived from the tristimulus values.

The formula therefore involves all three dimensions of colour space. A full explanation of the derivation of various whiteness formulae can be found in colour measurement literature for example ‘Colour, Research and Application’, Volume 19, Number 6, December 1994: Special Issue on Fluorescence, Part 1, pp 446, Rolf Griesser, or from CIE (the International Commission on Illumination publication).

The higher the Ganz whiteness measurement the whiter the substrate.

The following Ganz whiteness results shown in Table 2 were achieved when this experiment was carried out with different fabric types.

TABLE 2

| | Nylon | Polyester | Cotton | Polycotton |
|---|---|---|---|---|
| Before | 68 | 74 | 79 | 76 |
| wash | | | | |
| Control | 78 | 78 | 192 | 147 |
| 1 ppm | 79 | 82 | 209 | 164 |
| polymer | | | | |
| complex | | | | |
| 10 ppm | 100 | 121 | 210 | 174 |
| polymer | | | | |
| complex | | | | |
| 15 ppm | 107 | 137 | 209 | 172 |
| polymer | | | | |
| complex | | | | |

This shows that the addition of a polymer as a deposition 5 aid in combination with the particulate brightener gives a significant increase in the Ganz whiteness of the fabrics tested. Pursuant to the particular experimental parameters described a marked increase was seen for nylon and polyester.

1. A laundry composition comprising a particulate brightener, the particulate brightener comprising a fluorescent whitening agent and a carrier, wherein the particulate brightener has a deposition aid which deposits the particulate brightener on to consumer articles during the laundry wash process.

2. A laundry detergent composition comprising a particulate brightener as claimed in claim 1, wherein the deposition aid is a cationic polymer.

3. A laundry detergent composition comprising a particulate brightener as claimed in claim 1, wherein the carrier is urea formaldehyde.

4. A laundry detergent composition comprising a particulate brightener as claimed in claim 1, wherein the fluorescent whitening agent is present at levels of from 0.01 to 50 wt % based on the total weight percent of the particulate brightener.

5. A laundry detergent composition comprising a particulate brightener as claimed in claim 1, wherein the fluorescent whitening agent is present at levels of from 0.0005 to 10 wt % of the composition based on the total weight percent of the composition.

6. A laundry detergent composition comprising a particulate brightener as claimed in claim 1, wherein the particle size of the carrier is from 0.01 μm to 50 μm.

7. A laundry composition of a particulate brightener as claimed in claim 1, wherein the laundry detergent composition comprises;
(a) from 5 to 60 wt % of organic surfactant,
(b) optionally from 5 to 80 wt % of detergency builder,
(c) from 0 to 50 wt % of particulate brightener, and
optionally other ingredients to 100 wt %.

8. Use of a particulate brightener as claimed in claim 1, to whiten consumer articles during the wash process.

9. A process for the laundering of textile fabrics which comprises a wash step in which the fabrics are immersed in an aqueous wash liquor comprising the particulate brightener as claimed in claim 1, a detergent surfactant, optionally a detergency builder and optionally other detergent ingredients.

10. A process for the laundering of textile fabrics which comprises;
(a) a wash step in which the fabrics are immersed in an aqueous wash liquor comprising a detergent surfactant, a detergency builder and optionally other detergent ingredients, and
(b) a rinse or pretreatment step in which the fabrics are immersed for at least 30 seconds in an aqueous rinse liquor comprising at least 1 wt % of the particulate brightener as claimed in claims 1 to 7, and a deposition aid, and optionally a non-surfactant water soluble salt.
